(19) United States
(12) Patent Application Publication
(10) Pub. No.: US 2014/0263507 A1
(43) Pub. Date: Sep. 18, 2014

(54) ANGLE-ADJUSTABLE WATER BOTTLE CAGE

(71) Applicant: BETO ENGINEERING AND MARKETING CO., LTD., Taichung City (TW)

(72) Inventor: Lopin WANG, Taichung City (TW)

(73) Assignee: BETO ENGINEERING AND MARKETING CO., LTD., Taichung City (TW)

(21) Appl. No.: 14/171,461

(22) Filed: Feb. 3, 2014

(30) Foreign Application Priority Data
Mar. 14, 2013 (TW) 102204690

(51) Int. Cl. B62J 11/00

(52) U.S. Cl. CPC B62J 11/00
USPC 224/414

(57) ABSTRACT

An angle-adjustable water bottle cage includes a cage body for holding a water bottle, a mounting assembly for fastening to a bicycle frame. The cage body provides a fastening member fastenable to the mounting assembly, and an anti-rotation member. The mounting assembly provides an anti-rotation member detachably abutted against the anti-rotation member of the cage body for enabling the cage body to be adjustably fastened to the mounting member by the fastening member in one of a series of angular positions.

### BACKGROUND OF THE INVENTION

1. Field of the Invention

The present invention relates to water bottle cages for bikes and more particularly, to an angle-adjustable water bottle cage.

2. Description of the Related Art

Conventional water bottle cages for bikes commonly comprise a cage body for holding a water bottle, a substantially C-shaped mounting assembly for fastening to a bicycle frame of a bicycle, and a screw bolt for fastening the cage body to the C-shaped mounting assembly to keep the axis of the C-shaped mounting assembly and the axis of the cage body in parallel. Thus, the location of the mounting assembly at the bicycle frame determines the location and angle of the water bottle. This mounting arrangement affects the user's convenience in use. For instance, a conventional water bottle cage cannot be mounted at the handlebars of a bicycle.

### SUMMARY OF THE INVENTION

The present invention has been accomplished under the circumstances in view. It is the main object of the present invention to provide an angle-adjustable water bottle cage, which allows the user to adjust the angular position of the cage body relative to the mounting assembly according to personal requirements.

To achieve this and other objects of the present invention, an angle-adjustable water bottle cage in accordance with the present invention comprises a cage body for holding a water bottle, and a mounting assembly for securing the cage body to a bicycle frame of a bicycle. The cage body comprises a fastening member fastenable to the mounting assembly, and an anti-rotation member. The mounting assembly comprises an anti-rotation member detachably abutted against the anti-rotation member of the cage body for enabling the cage body to be adjustably fastened to the mounting member by the fastening member in one of a series of angular positions.

### BRIEF DESCRIPTION OF THE DRAWINGS

FIG. 1 is an exploded view of an angle-adjustable water bottle cage in accordance with the present invention.

FIG. 2 corresponds to FIG. 1 when viewed from an angle of 180-degrees away from the angle shown in FIG. 1.

FIG. 3 is a sectional assembly view of the present invention, illustrating the movable clamping member locked to the fixed clamping member.

FIG. 4 corresponds to FIG. 3, illustrating the movable clamping member opened from the fixed clamping member.

### DETAILED DESCRIPTION OF THE INVENTION

Referring to FIGS. 1 and 2, an angle-adjustable water bottle cage in accordance with the present invention is shown. The angle-adjustable water bottle cage comprises a cage body 10 for holding a water bottle (not shown), and a mounting assembly 20 for securing the cage body 10 to a frame of a bicycle (not shown).

The case body 10 is fastened to the mounting assembly 20 by a fastening member, for example, screw bolt 30. Further, the cage body 10 provides an integrated anti-rotation member 15, and the mounting assembly 20 provides an anti-rotation member 25 that is against the anti-rotation member 15 of the cage body 10, enabling the cage body 10 to be locked to the mounting assembly 20 by the screw bolt 30 at a predetermined angle.

The anti-rotation member 15 of the cage body 10 and the anti-rotation member 25 of the mounting assembly 20 are cylindrical members. The anti-rotation member 15 of the cage body 10 comprises a through hole 16 axially disposed in the center thereof for the passing of the screw bolt 30, and an annular toothed portion 17 located at one end thereof around the through hole 16. The anti-rotation member 25 of the mounting assembly 20 comprises a screw hole 26 axially disposed in the center thereof for engagement with the screw bolt 30, and an annular toothed portion 27 located at one end thereof around the screw hole 26 for engagement with the annular toothed portion 17 of the anti-rotation member 15 of the cage body 10. Thus, the anti-rotation member 15 of the cage body 10 and the anti-rotation member 25 of the mounting assembly 20 can be abutted against each other to keep the anti-rotation member 15 of the cage body 10 and the anti-rotation member 25 of the mounting assembly 20 in a meshed condition at a selected angle relative to each other, and then the screw bolt 30 can be inserted through the through hole 16 and threaded into the screw hole 26 to adjustably lock the cage body 10 and the mounting assembly 20 together. This design facilitates adjustment of the angular position of the cage body 10 relative to the mounting assembly 20.

Further, the mounting assembly 20 comprises a fixed clamping member 21 and secured with the anti-rotation member 25 to the cage body 10 by the screw bolt 30, a movable clamping member 22 having one end thereof pivotally connected to the fixed clamping member 21 and an opposite end thereof providing a recessed hole 23 and an end notch 33 in communication with the recessed hole 23, a pivot pin 24 mounted at one end of the fixed clamping member 21 remote from the cage body 10, and a locking member 28 transversely threaded into the pivot pin 24 for rotation with the pivot pin 24 relative to the fixed clamping member 21 and having a head 29 at one end thereof. Thus, the locking member 28 can be biased with the pivot pin 24 relative to the fixed clamping member 21 and moved through the end notch 33 into or out of the recessed hole 23. When the locking member 28 is moved through the end notch 33 into the recessed hole 23, the head 29 is engaged with the movable clamping member 22 to lock the movable clamping member 22 to the fixed clamping member 21. When the movable clamping member 22 and the fixed clamping member 21 are locked together, they exhibit an annular configuration. Further, elastic linings 31 and 32 are respectively attached to the fixed clamping member 21 and the movable clamping member 22 at an inner side to face toward each other for direct contact with the frame tube of the bicycle frame, enabling the mounting assembly 20 to be firmly secured to the bicycle frame. In application, loosen the locking member 28 and turn the locking member 28 out of the end notch 33 and recessed hole 23 of the movable clamping member 22, and then open the movable clamping member 22 from the fixed clamping member 20, and then attach the fixed clamping member 21 to the selected frame tube of the bicycle frame, and then close the movable clamping member 22 on the fixed clamping member 21, and then move the locking member 28 through the end notch 33 of the movable clamping member 22 into the recessed hole 23, and then fasten tight the locking member 28 to force the head 29 into engagement with the recessed hole 23 of the movable clamping member 22, and thus, the mounting assembly 20 is locked to the bicycle frame.

In this embodiment, the through hole 16 of the cage body 10 can be broadly defined as connection means, and the screw hole 26 of the mounting assembly 20 can also be broadly defined as connection means. Thus, the connection means of the mounting assembly 20 can be made in the form of a through hole, screw hole or screw rod; the connection means of the cage body 10 can be made in the form of a through hole, screw hole or screw rod; or alternatively, the connection member 30 can be made in the form of a screw rod or screw nut.

What is claimed is:

1. An angle-adjustable water bottle cage, comprising a cage body for holding a bottle, and a mounting assembly for securing said cage body to a bicycle frame of a bicycle, wherein said cage body comprises a fastening member fastenable to said mounting assembly, and an anti-rotation member; said mounting assembly comprises an anti-rotation member detachably abutted against the anti-rotation member of said cage body for enabling said cage body to be adjustably fastened to said mounting member by said fastening member in one of a series of angular positions.

2. The angle-adjustable water bottle cage as claimed in claim 1, wherein said cage body comprises a connection means; said mounting assembly comprises a connection means detachably connected to the connection means of said cage body by said fastening member.

3. The angle-adjustable water bottle cage as claimed in claim 2, wherein said the anti-rotation member of said cage body and the anti-rotation member of said mounting assembly have an annular configuration; the connection means of said cage body is disposed at the center of the anti-rotation member thereof; the connection means of said mounting assembly is disposed at the center of the anti-rotation member thereof.

4. The angle-adjustable water bottle cage as claimed in claim 2, wherein the connection means of said cage body is selectively made in the form of a through hole, screw hole or screw rod; the connection means of said mounting assembly is selectively made in the form of a through hole, screw hole or screw rod.

5. The angle-adjustable water bottle cage as claimed in claim 1, wherein the anti-rotation member of said case body and the anti-rotation member of said mounting assembly each comprise an annular toothed portion.

6. The angle-adjustable water bottle cage as claimed in claim 1, wherein said mounting assembly comprises a fixed clamping member carrying the anti-rotation member of mounting assembly and detachably fastened to said cage body by said fastening member, and a movable clamping member having one end thereof pivotally connected to one end of said fixed clamping member.

7. The angle-adjustable water bottle cage as claimed in claim 6, wherein said movable clamping member of said mounting assembly has a recessed hole located at an opposite end thereof; said mounting assembly further comprises a pivot pin rotatably mounted in an opposite end of said fixed clamping member, and a locking member transversely threaded into said pivot pin and turnable with said pivot pin, said locking member comprising a head located at one end thereof for engagement with said movable clamping member.

8. The angle-adjustable water bottle cage as claimed in claim 7, wherein said movable clamping member of said mounting assembly further comprises an end notch in communication with said recessed hole for enabling said locking member to be moved in and out of said recessed hole.

9. The angle-adjustable water bottle cage as claimed in claim 6, wherein said fixed clamping member and said movable clamping member of said mounting assembly exhibit an annular configuration when closed together.

10. The angle-adjustable water bottle cage as claimed in claim 6, wherein said fixed clamping member and said movable clamping member of said mounting assembly each have an inner side thereof respectively mounted with a respective elastic lining.
